(19) United States
(12) Patent Application Publication
(10) Pub. No.: US 2017/0171539 A1
(43) Pub. Date: Jun. 15, 2017

(54) SYSTEM FOR DISPLAYING AN IMAGE FOR A HEAD MOUNTED DISPLAY

(71) Applicant: COLOPL, INC., Tokyo (JP)

(72) Inventor: Atsushi INOMATA, Kanagawa (JP)

(21) Appl. No.: 15/372,415

(22) Filed: Dec. 8, 2016

(30) Foreign Application Priority Data
Dec. 15, 2015 (JP) 2015-244171

(51) Int. Cl. H04N 13/04

(52) U.S. Cl. CPC H04N 13/0497; H04N 13/044; H04N 13/0479

(57) ABSTRACT

To provide a comfortable operability to a user when the user uses a head mounted display (HMD) to view a 360-degree moving image having a determined time axis, provided is a system for executing a method of providing, to the HMD, a 360-degree moving image having a determined time axis. The method includes controlling, in response to an inclination from an initial angle of the HMD, a time axis of the 360-degree moving image to be displayed on the HMD based on the inclination. The method further includes generating an image of the 360-degree moving image based on the controlled time axis. The method further includes outputting the generated image of the 360-degree moving image to the HMD.

### BACKGROUND

This disclosure relates to a system for displaying a 360-degree moving image on a head mounted display (HMD).

Recently, using an HMD to view a 360-degree virtual reality (VR) moving image has begun to be proposed.

### SUMMARY

This disclosure helps to provide a comfortable operability to a user when the user uses an HMD to view a 360-degree moving image having a determined time axis.

In order to help achieve comfortable operability, according to at least one embodiment of this disclosure, there is provided a system for executing a method of providing, to a head mounted display, a 360-degree moving image having a determined time axis. The method includes controlling, in response to an inclination from an initial angle of the head mounted display, a time axis of the 360-degree moving image to be displayed on the head mounted display based on the inclination. The method further includes generating an image of the 360-degree moving image based on the controlled time axis. The method further includes outputting the generated image of the 360-degree moving image to the head mounted display.

According to this disclosure, providing a comfortable operability to the user when the user uses the HMD to view the 360-degree moving image having the determined time axis is possible.

Other features and advantages of this disclosure are made clear from the following description of embodiments of this disclosure, the attached drawings, and the description of the appended claims.

### BRIEF DESCRIPTION OF THE DRAWINGS

FIG. 1 is an illustration of an HMD system including an HMD according to at least one embodiment of this disclosure.

FIG. 2 is a block diagram for schematically illustrating a basic configuration of a control circuit unit according to at least one embodiment.

FIG. 3 is a diagram for illustrating a three-dimensional coordinate system about a head of a user wearing the HMD according to at least one embodiment.

FIG. 4 is a diagram for illustrating a relationship between position tracking performed by a movement sensor and a virtual camera arranged in a virtual space according to at least one embodiment.

FIG. 5 is a diagram for illustrating an example of a method of determining a line-of-sight direction according to at least one embodiment.

FIG. 6 is a block diagram for illustrating a function of the control circuit unit, for achieving virtual space display processing or the like in the HMD system according to at least one embodiment.

FIG. 7 is a flow chart for illustrating general processing for displaying an image of a 360-degree moving image on the HMD according to at least one embodiment.

FIG. 8 is a flow chart for illustrating basic processing for displaying an image of a 360-degree moving image on the HMD, which is achieved by a system according to at least one embodiment of this disclosure.

FIG. 9 is a flow chart for illustrating an example of processing from Step 806 to Step 810 in FIG. 8 according to at least one embodiment.

FIG. 10 is a flow chart for illustrating an example of processing from Step 806 to Step 810 in FIG. 8 according to at least one embodiment.

FIG. 11 is a flow chart for illustrating an example of processing from Step 806 to Step 810 in FIG. 8 according to at least one embodiment.

FIG. 12A is a YZ plane diagram of a field-of-view region as viewed from an X direction according to at least one embodiment.

FIG. 12B is an XZ plane diagram of the field-of-view region as viewed from a Y direction according to at least one embodiment.

FIG. 12C is a diagram for illustrating an example of a field-of-view image to be displayed on a display according to at least one embodiment.

FIG. 13A is a YZ plane diagram of the field-of-view region as viewed from the X direction according to at least one embodiment.

FIG. 13B is an XZ plane diagram of the field-of-view region as viewed from the Y direction according to at least one embodiment.

FIG. 13C is a diagram for illustrating an example of the field-of-view image to be displayed on the display according to at least one embodiment.

FIG. 14A is a YZ plane diagram of the field-of-view region as viewed from the X direction according to at least one embodiment.

FIG. 14B is an XZ plane diagram of the field-of-view region as viewed from the Y direction according to at least one embodiment.

FIG. 14C is a diagram for illustrating an example of the field-of-view image to be displayed on the display according to at least one embodiment.

FIG. 15A is a YZ plane diagram of the field-of-view region as viewed from the X direction according to at least one embodiment.

FIG. 15B is an XZ plane diagram of the field-of-view region as viewed from the Y direction according to at least one embodiment.

FIG. 15C is a diagram for illustrating an example of the field-of-view image to be displayed on the display according to at least one embodiment.

FIG. 16A is a YZ plane diagram of the field-of-view region as viewed from the X direction according to at least one embodiment.

FIG. 16B is an XZ plane diagram of the field-of-view region as viewed from the Y direction according to at least one embodiment.

FIG. 16C is a diagram for illustrating an example of the field-of-view image to be displayed on the display according to at least one embodiment.

FIG. 17A is a YZ plane diagram of the field-of-view region as viewed from the X direction according to at least one embodiment.

FIG. 17B is an XZ plane diagram of the field-of-view region as viewed from the Y direction according to at least one embodiment.

FIG. 17C is a diagram for illustrating an example of the field-of-view image to be displayed on the display according to at least one embodiment.

FIG. 18A is a YZ plane diagram of the field-of-view region as viewed from the X direction according to at least one embodiment.

FIG. 18B is an XZ plane diagram of the field-of-view region as viewed from the Y direction according to at least one embodiment.

FIG. 18C is a diagram for illustrating an example of the field-of-view image to be displayed on the display according to at least one embodiment.

FIG. 19A is a YZ plane diagram of the field-of-view region as viewed from the X direction according to at least one embodiment.

FIG. 19B is an XZ plane diagram of the field-of-view region as viewed from the Y direction according to at least one embodiment.

FIG. 19C is a diagram for illustrating an example of the field-of-view image to be displayed on the display according to at least one embodiment.

FIG. 20A is a YZ plane diagram of the field-of-view region as viewed from the X direction according to at least one embodiment.

FIG. 20B is an XZ plane diagram of the field-of-view region as viewed from the Y direction according to at least one embodiment

FIG. 20C is a diagram for illustrating an example of the field-of-view image to be displayed on the display according to at least one embodiment.

FIG. 21A is a YZ plane diagram of the field-of-view region as viewed from the X direction according to at least one embodiment.

FIG. 21B is an XZ plane diagram of the field-of-view region as viewed from the Y direction according to at least one embodiment.

FIG. 21C is a diagram for illustrating an example of the field-of-view image to be displayed on the display according to at least one embodiment.

FIG. 22A is a YZ plane diagram of the field-of-view region as viewed from the X direction according to at least one embodiment.

FIG. 22B is an XZ plane diagram of the field-of-view region as viewed from the Y direction according to at least one embodiment.

FIG. 22C is a diagram for illustrating an example of the field-of-view image to be displayed on the display according to at least one embodiment.

FIG. 23A is a YZ plane diagram of the field-of-view region as viewed from the X direction according to at least one embodiment.

FIG. 23B is an XZ plane diagram of the field-of-view region as viewed from the Y direction according to at least one embodiment.

FIG. 23C is a diagram for illustrating an example of the field-of-view image to be displayed on the display according to at least one embodiment.

### DETAILED DESCRIPTION

First, at least one embodiment of this disclosure is described by enumerating contents thereof. A system for operating an object within a virtual space about three axes according to at least one embodiment of this disclosure has the following configurations.

(Item 1) A system for executing a method of providing, to a head mounted display, a 360-degree moving image having a determined time axis, the method includes controlling, in response to an inclination from an initial angle of the head mounted display, a time axis of the 360-degree moving image to be displayed on the head mounted display based on the inclination. The method further includes generating an image of the 360-degree moving image based on the controlled time axis. The method further includes outputting the generated image of the 360-degree moving image to the head mounted display.

According to the system of Item 1, providing a comfortable operability to a user when the user uses an HMD to view a 360-degree moving image having a determined time axis is possible.

(Item 2) A system according to Item 1, in which the controlling includes, when the inclination is an inclination in one direction about a pitch-direction axis with respect to the initial angle and is larger than a first threshold fast-forwarding the 360-degree moving image continuously when the head mounted display is further inclined in one direction about a yaw-direction axis with respect to the initial angle and when the inclination is larger than a second threshold. The controlling further includes rewinding the 360-degree moving image continuously when the head mounted display is further inclined in another direction about the yaw-direction axis with respect to the initial angle and when the inclination is larger than a third threshold.

(Item 3) A system according to Item 2, where the fast-forwarding includes fast-forwarding the 360-degree moving image continuously at a speed that is a first multiple of a normal playback speed when the inclination in the one direction about the yaw-direction axis is larger than the second threshold and is equal to or smaller than a fourth threshold. The fast forwarding further includes fast-forwarding the 360-degree moving image continuously at a speed that is a second multiple, which is larger than the first multiple, of the normal playback speed when the inclination in the one direction about the yaw-direction axis is larger than the fourth threshold. The rewinding includes rewinding the 360-degree moving image continuously at a speed that is a third multiple of the normal playback speed when the inclination in the another direction about the yaw-direction axis is larger than the third threshold and is equal to or smaller than a fifth threshold. The rewinding further includes rewinding the 360-degree moving image continuously at a speed that is a fourth multiple, which is larger than the third multiple, of the normal playback speed when the inclination in the another direction about the yaw-direction axis is larger than the fifth threshold.

(Item 4) A system according to Item 2 or 3, in which the method further includes displaying, when the inclination is the inclination in the one direction about the pitch-direction axis with respect to the initial angle and is larger than the first threshold, a first thumbnail at a position on the head mounted display corresponding to a line of sight of a user wearing the head mounted display. The method further includes displaying, in the first thumbnail, one of at least a part of the 360-degree moving image that is continuously fast-forwarding and at least a part of the 360-degree moving image that is continuously rewinding.

(Item 5) A system according to Item 4, in which the fast-forwarding and/or the rewinding includes blurring a part excluding the first thumbnail of the 360-degree moving image to be displayed on the head mounted display.

(Item 6) A system according to any one of Items 2 to 5, in which, when the inclination about the yaw-direction axis is returned to be equal to or smaller than one of the second threshold and the third threshold, and when the inclination about the pitch-direction axis is returned to be equal to or smaller than the first threshold, the 360-degree moving image is displayed on the head mounted display at a normal playback speed.

(Item 7) A system according to any one of Items 2 to 6, in which the controlling includes, when the inclination is an inclination in another direction about the pitch-direction axis with respect to the initial angle and is larger than a sixth threshold displaying, on the head mounted display, a first object representing the time axis of the 360-degree moving image and a second object for operating the first object. The controlling further includes moving, when the head mounted display is further inclined in one direction about the yaw-direction axis with respect to the initial angle, the second object on the first object in the one direction. The controlling further includes moving, when the head mounted display is further inclined in another direction about the yaw-direction axis with respect to the initial angle, the second object on the first object in the another direction. The controlling further includes skipping, when the inclination about the pitch-direction axis is returned to be equal to or smaller than the sixth threshold, the 360-degree moving image to a scene corresponding to a present position of the second object on the first object.

(Item 8) A system according to Item 7, in which the method further includes displaying, when the inclination is the inclination in the another direction about the pitch-direction axis with respect to the initial angle and is larger than the sixth threshold, a second thumbnail at a position on the head mounted display corresponding to a line of sight of a user wearing the head mounted display. The method further includes displaying, in the second thumbnail, at least apart of a still image of the 360-degree moving image corresponding to the present position of the second object on the first object.

(Item 9) A system according to Item 7 or 8, in which, while the first object and the second object are displayed, the 360-degree moving image is played on the head mounted display at a normal playback speed.

(Item 10) A system according to Item 1, in which the controlling includes, when the inclination is an inclination in one direction about a pitch-direction axis with respect to the initial angle and is larger than a seventh threshold displaying, on the head mounted display, a first object representing the time axis of the 360-degree moving image and a second object for operating the first object. The controlling further includes moving, when the head mounted display is further inclined in one direction about the yaw-direction axis with respect to the initial angle, the second object on the first object in the one direction. The controlling further includes moving, when the head mounted display is further inclined in another direction about the yaw-direction axis with respect to the initial angle, the second object on the first object in the another direction. The controlling further includes skipping, when the inclination about the pitch-direction axis is returned to be equal to or smaller than the seventh threshold, the 360-degree moving image to a scene corresponding to a present position of the second object on the first object.

(Item 11) A system according to Item 10, in which the method further includes displaying, when the inclination is the inclination in the one direction about the pitch-direction axis with respect to the initial angle and is larger than the seventh threshold, a third thumbnail at a position on the head mounted display corresponding to a line of sight of a user wearing the head mounted display. The method further includes displaying, in the third thumbnail, at least a part of a still image of the 360-degree moving image corresponding to the present position of the second object on the first object.

(Item 12) A system according to Item 10 or 11, in which, while the first object and the second object are displayed, the 360-degree moving image is played on the head mounted display at a normal playback speed.

(Item 13) A system according to any one of Items 2 to 6 and Items 10 to 12, in which the controlling includes, when the inclination is an inclination in another direction about the pitch-direction axis with respect to the initial angle and is larger than an eighth threshold advancing the 360-degree moving image continuously at a speed slower than a normal playback speed when the head mounted display is further inclined in the one direction about the yaw-direction axis with respect to the initial angle and when the inclination is larger than a ninth threshold. The controlling further includes rewinding the 360-degree moving image continuously at a speed slower than the normal playback speed when the head mounted display is further inclined in the another direction about the yaw-direction axis with respect to the initial angle and when the inclination is larger than a tenth threshold.

(Item 14) A system according to Item 13, in which the controlling includes continuing one of the advancing the 360-degree moving image continuously and the rewinding the 360-degree moving image continuously when the inclination about the pitch-direction axis is returned to be equal to or smaller than the eighth threshold. The controlling further includes one of temporarily stopping the 360-degree moving image and advancing the 360-degree moving image at the normal playback speed when the inclination about the pitch-direction axis is increased to be larger than the eighth threshold again and is thereafter returned to be equal to or smaller than the eighth threshold again.

(Item 15) A system according to any one of Items 2 to 6 and Items 10 to 12, in which the controlling includes, when the inclination is an inclination in another direction about the pitch-direction axis with respect to the initial angle and is larger than an eighth threshold, advancing the 360-degree moving image continuously at a speed slower than a normal playback speed.

(Item 16) A system according to Item 15, in which the controlling includes continuing advancing the 360-degree moving image continuously when the inclination about the pitch-direction axis is returned to be equal to or smaller than the eighth threshold. The controlling further includes one of temporarily stopping the 360-degree moving image and advancing the 360-degree moving image at the normal playback speed when the inclination about the pitch-direction axis is increased to be larger than the eighth threshold again and is thereafter returned to be equal to or smaller than the eighth threshold again.

(Item 17) A computer, including a processor configured to execute any one of Items 1 to 16 to execute the method.

Exemplary embodiments of this disclosure are described below with reference to the attached drawings. This disclosure is not limited to those exemplary embodiments, and is defined by the appended claims. One of ordinary skill in the art would understand that this disclosure includes all modifications within the appended claims and the equivalents thereof. In the following description, like elements are denoted by like reference symbols in the description of the drawings, and redundant description thereof is omitted.

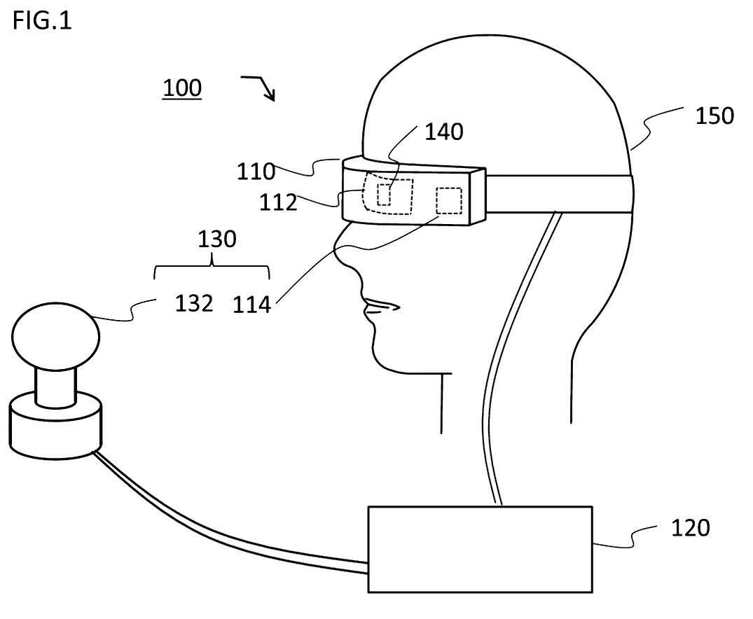

FIG. 1 is an illustration of an HMD system 100 including an HMD 110 according to at least one embodiment of this disclosure. The HMD system 100 includes the HMD 110 to be worn on a head 150 of a user, a control circuit unit 120, and a movement sensor 130.

The HMD 110 includes a display 112 that is a non-transmissive or partially transmissive display device, a sensor unit 114, and an eye gaze sensor 140. The control circuit unit 120 is configured to cause the display 112 to display a right-eye image and a left-eye image, to thereby provide a three-dimensional image using binocular parallax as a virtual space. The display 112 is arranged right in front of the user's eyes, and thus the user can be immersed to the virtual space. In this disclosure, with use of the HMD 110, the user is provided with a virtual space in which the user can look around all directions of upward, downward, right, and left, which is provided by a 360-degree moving image. The virtual space may further include various objects that can be operated by the user, menu images, and the like.

The display 112 may include a right-eye sub-display configured to provide a right-eye image, and a left-eye sub-display configured to provide a left-eye image. Further, as long as the right-eye image and the left-eye image can be provided, the display 112 may be constructed of one display device. For example, a shutter configured to enable recognition of a display image with only one eye may be switched at high speed, to thereby independently provide the right-eye image and the left-eye image.

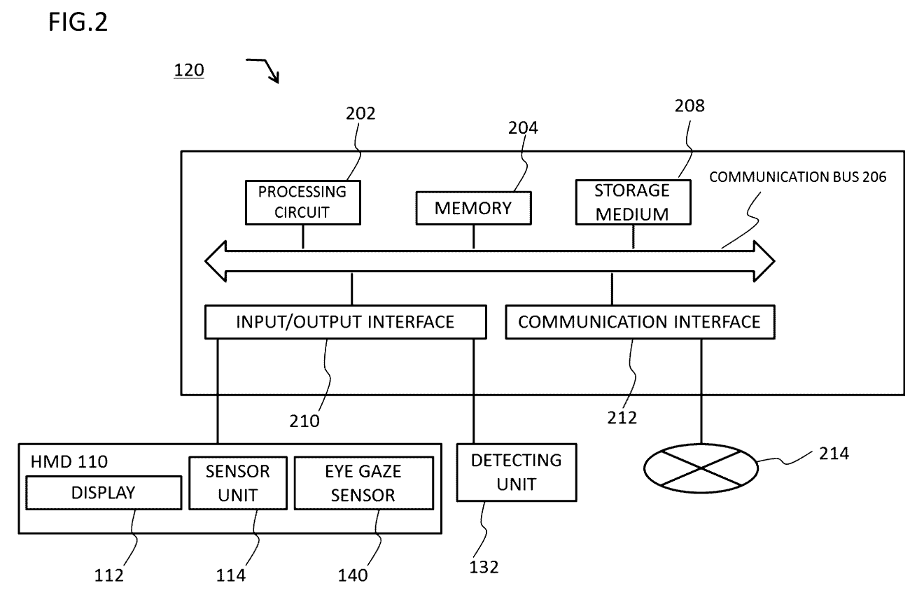

The control circuit unit 120 is a computer to be connected to the HMD 110. FIG. 2 is a block diagram for schematically illustrating a basic configuration of the control circuit unit 120. As illustrated in FIG. 2, the control circuit unit 120 includes a processing circuit 202, a memory 204, a storage medium 208, an input/output interface 210, and a communication interface 212, which are connected to each other with a communication bus 206 used as a data transmission path. The processing circuit 202 includes various processing circuits such as a central processing unit (CPU), a micro-processing unit (MPU), and a graphics processing unit (GPU), and has a function of controlling the entire control circuit unit 120 and HMD system 100. The memory 204 includes a read only memory (ROM), a random access memory (RAM), and the like, and is configured to temporarily store programs to be used by the processing circuit 202 and control data such as calculation parameters. The storage medium 208 includes non-volatile storage devices such as a flash memory and a hard disk drive (HDD), and is configured to store data of the 360-degree moving image, data relating to various images and objects, simulation programs, and user authentication programs, and may further be configured to construct a database including tables for managing various kinds of data. The input/output interface 210 includes various wire connection terminals such as a universal serial bus (USB) terminal, a digital visual interface (DVI) terminal, and a high-definition multimedia interface (HDMI)®terminal, and various processing circuits for wireless connection. The input/output interface 210 is configured to connect the HMD 110, various sensors including the movement sensor 130, an external controller, and the like to each other. The communication interface 212 includes various wire connection terminals for communicating to/from an external device via a network 214, and various processing circuits for wireless connection. The communication interface 212 is configured to adapt to various communication standards or protocols for communication via a local area network (LAN) or the Internet.

The control circuit unit 120 is configured to execute a predetermined application stored in the memory 204 or the storage medium 208, to thereby reproduce the 360-degree moving image to present a virtual space on the display 112. Further, the memory 204 or the storage medium 208 stores a program for providing, to the head mounted display, the 360-degree moving image having a determined time axis, according to at least one embodiment of this disclosure. Further, the memory 204 or the storage medium 208 may store a program for operating various objects to be displayed in the virtual space, or for displaying and controlling various menu images and the like. The control circuit unit 120 is not required to be mounted on the HMD 110, and may be constructed as different hardware (for example, a known personal computer, or a server computer via a network). Further, only a part of the functions of the control circuit unit 120 may be mounted on the HMD 110, and the remaining functions thereof may be mounted on different hardware.

The movement sensor 130 is configured to detect information relating to a position and an inclination of the HMD 110. The movement sensor 130 includes the sensor unit 114 and a detecting unit 132. The sensor unit 114 may include a plurality of light sources. The light source is, for example, an LED configured to emit an infrared ray. The detecting unit 132 is, for example, an infrared sensor, and is configured to detect the infrared ray from the light source as a detection point of the HMD 110, to thereby detect over time information relating to a position and an angle in a real space of the HMD 110 that are based on the movement of the user. Then, the time change of the position and the angle of the HMD 110 can be determined based on the temporal change of the information detected by the detecting unit 132, and thus information relating to the movement of the HMD 110 can be detected.

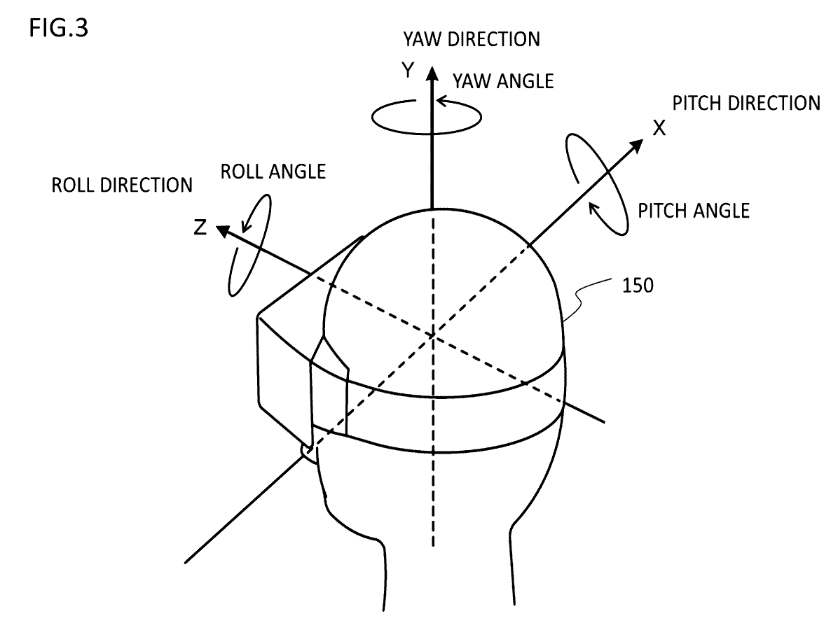

The information relating to the position and the inclination acquired by the movement sensor 130 is described with reference to FIG. 3. A three-dimensional coordinate system is defined about the head 150 of the user wearing the HMD 110. A perpendicular direction in which the user stands upright is defined as a yaw direction, a front-rear direction being orthogonal to the yaw direction and connecting between the user and the center of the display 112 is defined as a roll direction, and a lateral direction orthogonal to the yaw direction and the roll direction is defined as a pitch direction. With this, the temporal change in position of the user in the three-dimensional space is acquired. Further, a pitch angle being an inclination angle of the HMD 110 about a pitch-direction axis, a yaw angle being an inclination angle of the HMD 110 about a yaw-direction axis, and a roll angle being an inclination angle of the HMD 110 about a roll-direction axis are acquired.

The movement sensor 130 may be constructed of only one of the detecting unit 132 or the sensor unit 114 fixed near the display 112. The sensor unit 114 may be a geomagnetic sensor, an acceleration sensor, or a gyroscope, and is configured to use at least one of those sensors to detect the position and the inclination of the HMD 110 (in particular, the display 112) worn on the head 150 of the user. With this, the information relating to the movement of the HMD 110 can be detected. For example, the angular velocity sensor can detect over time the angular velocity about three axes of the HMD 110 based on the movement of the HMD 110, and can determine the time change of the angle about each axis. In this case, the detecting unit 132 may be omitted. Further, the detecting unit 132 may include an optical camera. In this case, the information relating to the movement of the HMD 110 can be detected based on the image information, and thus the sensor unit 114 may be omitted.

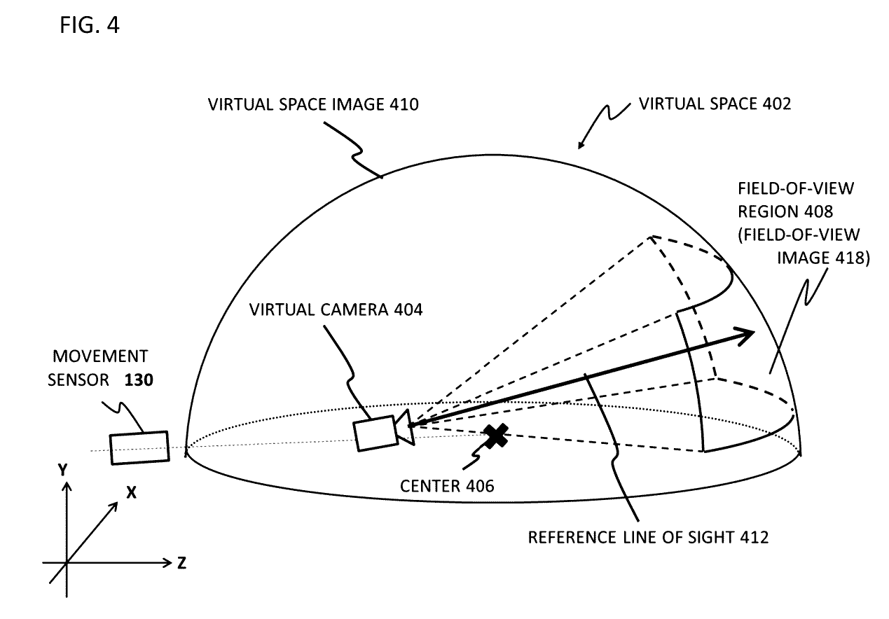

A function of detecting the information relating to the position and the inclination of the HMD 110 with use of the movement sensor 130 is referred to as “position tracking”. FIG. 4 is an illustration of the relationship between the position tracking performed by the movement sensor 130 and a virtual camera 404 arranged in a virtual space 402. In order to describe the positional relationship between the virtual camera 404 and the movement sensor 130, in the following, the position of the movement sensor 130 is set as a position of the detecting unit 132 when the detecting unit 132 is provided, and is set as the position of the sensor unit 114 when the detecting unit 132 is not provided. The virtual camera 404 is arranged inside the virtual space 402, and the movement sensor 130 is virtually arranged outside of the virtual space 402 (in the real space).

The virtual space 402 is formed into a celestial sphere shape having a plurality of substantially-square or substantially-rectangular mesh sections. Each mesh section is associated with space information of the virtual space 402, and a field-of-view region 408 (field-of-view image 418) is defined based on this space information. In at least one embodiment, in an XZ plane, a center 406 of the celestial sphere to be always arranged on a line connecting between the virtual camera 404 and the movement sensor 130 is adjusted. For example, the virtual camera 404 may be always arranged at the center 406. Further, when the user wearing the HMD 110 moves, and thus the position of the virtual camera 404 moves in the X direction, the region of the virtual space 402 may be changed such that the center 406 is positioned on the line segment between the virtual camera 404 and the movement sensor 130. In those cases, the position of the virtual camera 404 in the virtual space 402 is fixed, and only the inclination thereof changes. Meanwhile, when the position of the virtual camera 404 is moved in association with the movement of the movement sensor 130 in XYZ directions, the position of the virtual camera 404 in the virtual space 402 is set variable.

The eye gaze sensor 140 has an eye tracking function of detecting directions of lines of sight of the user's right and left eyes. In at least one embodiment, the eye gaze sensor 140 includes a right-eye sensor and a left-eye sensor, which are respectively configured to detect the directions of the lines of sight of the right and left eyes, to thereby detect a line-of-sight direction in which the user focuses his/her gaze. The eye gaze sensor 140 can employ a known sensor having an eye tracking function. For example, infrared light may be radiated to each of the right eye and the left eye to acquire reflection light from the cornea or the iris, to thereby obtain a rotational angle of the eyeball.

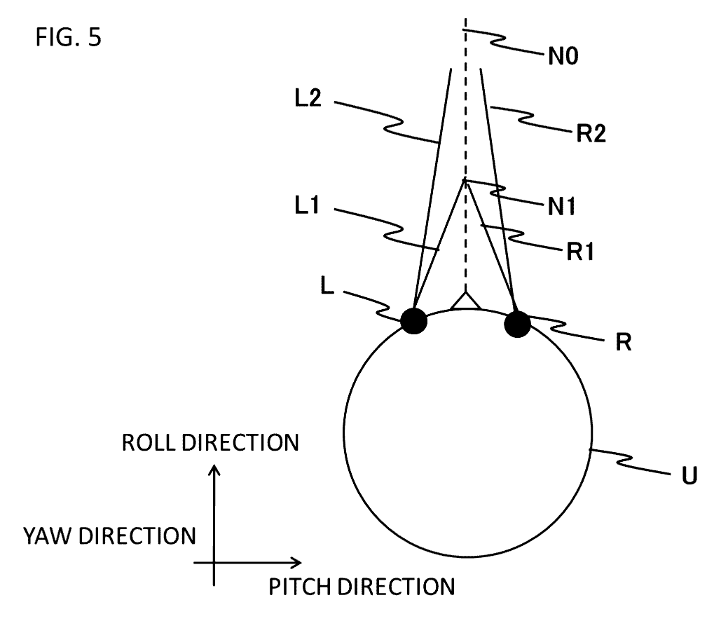

As illustrated in FIG. 5, the eye gaze sensor 140 is configured to detect line-of-sight directions of a right eye R and a left eye L of a user U. When the user U is looking at a near place, lines of sight R1 and L1 are detected, and a point of gaze N1 being an intersection of the lines of sight R1 and L1 is identified. Further, when the user is looking at a far place, lines of sight R2 and L2, which form smaller angles with the roll direction as compared to the lines of sight R1 and L1, are identified. After the point of gaze N1 is identified, a line-of-sight direction N0 of the user U is identified. The line-of-sight direction N0 is a direction in which the line of sight of the user U is actually directed with both eyes. The line-of-sight direction N0 is defined as, for example, an extension direction of a straight line that passes through the point of gaze N1 and the midpoint of the right eye R and the left eye L of the user U.

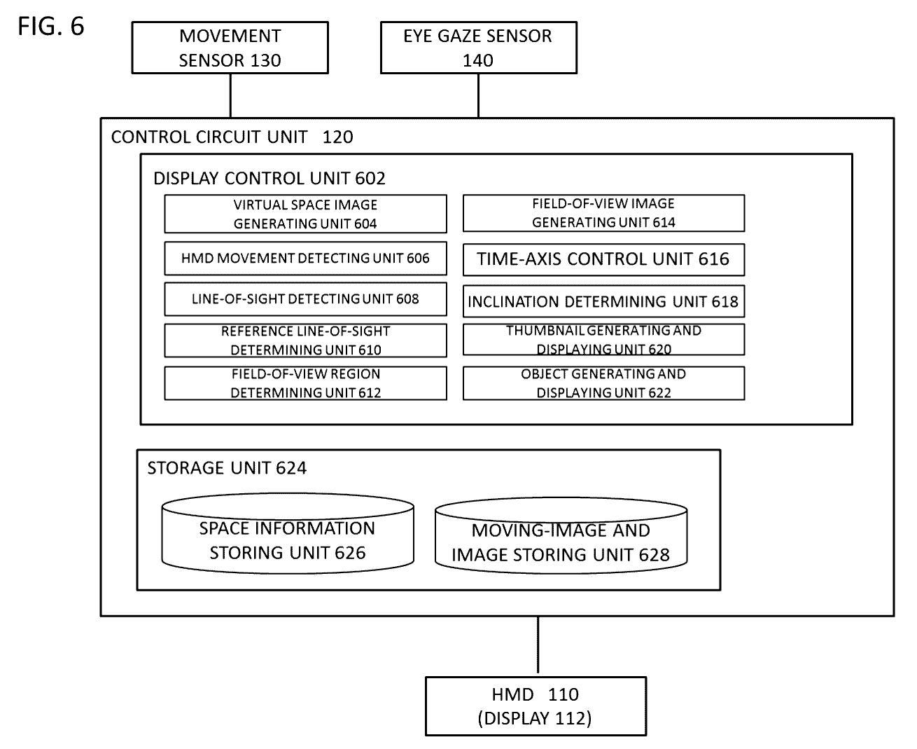

FIG. 6 is a block diagram for illustrating the function of the control circuit unit 120, for achieving, for example, display processing of the virtual space 402 in the HMD system 100. The control circuit unit 120 is configured to control output of an image to the display 112 mainly based on the input from the movement sensor 130 and the eye gaze sensor 140.

The control circuit unit 120 includes a display control unit 602 and a storage unit 624. The display control unit 602 includes a virtual space image generating unit 604, an HMD movement detecting unit 606, a line-of-sight detecting unit 608, a reference line-of-sight determining unit 610, a field-of-view region determining unit 612, a field-of-view image generating unit 614, a time-axis control unit 616, an inclination determining unit 618, a thumbnail generating and displaying unit 620, and an object generating and displaying unit 622. The storage unit 624 includes a space information storing unit 626 and a moving-image and image storing unit 628, and further includes various kinds of data necessary for calculation for providing, to the display 112, output information corresponding to the input from the movement sensor 130 or the eye gaze sensor 140. The moving-image and image storing unit 628 may store the 360-degree moving image.

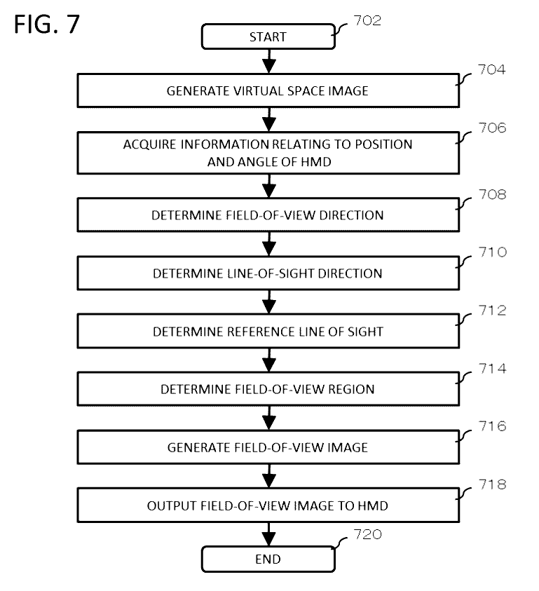

FIG. 7 is a flow chart for illustrating general processing for displaying an image of the 360-degree moving image on the HMD 110.

With reference to FIG. 6 and FIG. 7, general processing of the HMD system 100 for providing the image of the 360-degree moving image is described. The virtual space 402 may be provided through interaction between the HMD 110 (eye gaze sensor 140 or movement sensor 130) and the control circuit unit 120.

The processing starts in Step 702. In Step 704, the control circuit unit 120 (virtual space image generating unit 604) refers to the space information storing unit 626 to generate a celestial-sphere virtual space image 410 (see FIG. 4) forming the virtual space 402 in which the user is immersed. The movement sensor 130 detects the position and the inclination of the HMD 110. The information detected by the movement sensor 130 is transmitted to the control circuit unit 120. In Step 706, the HMD movement detecting unit 606 acquires the position information and the inclination information of the HMD 110. In Step 708, the field-of-view direction is determined based on the acquired position information and inclination information.

When the eye gaze sensor 140 detects the movement of the eyeballs of the user's right and left eyes, the information is transmitted to the control circuit unit 120. In Step 710, the line-of-sight detecting unit 608 identifies the directions of the lines of sight of the right and left eyes, to thereby determine the line-of-sight direction NO. In Step 712, the reference line-of-sight determining unit 610 determines, as a reference line of sight 412, the line-of-sight direction NO of the user or the field-of-view direction determined based on the inclination of the HMD 110.

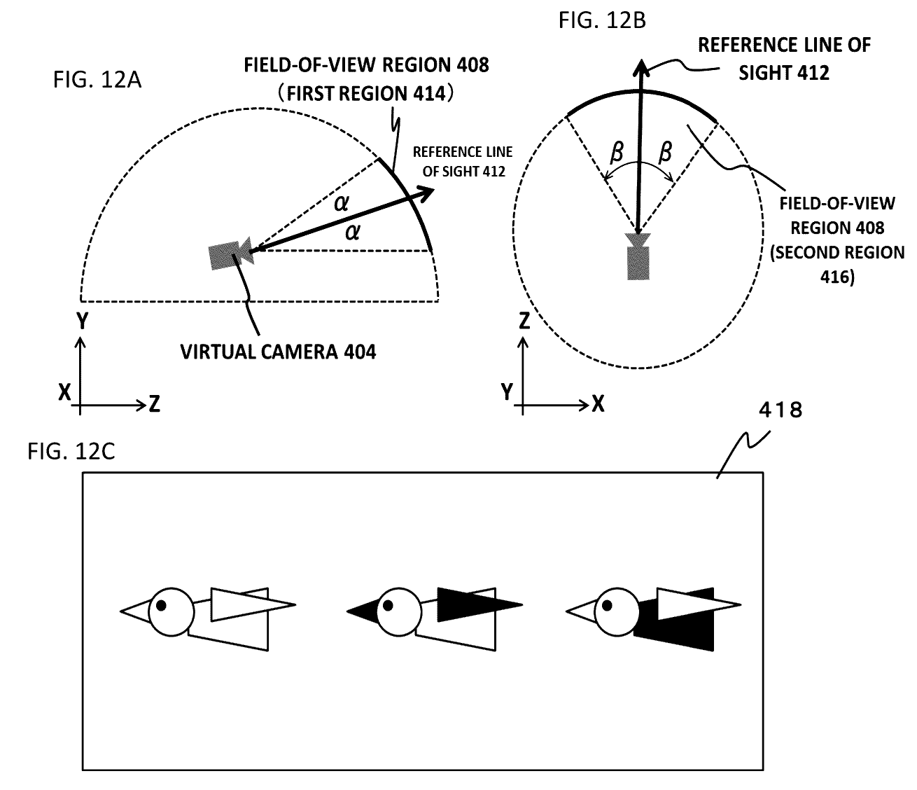

In Step 714, the field-of-view region determining unit 612 determines the field-of-view region 408 of the virtual camera 404 in the virtual space 402. As illustrated in FIG. 4, the field-of-view region 408 is a part of the virtual space image 410 forming the user's field of view (field-of-view image 418). The field-of-view region 408 is determined based on the reference line of sight 412, and the reference line of sight 412 is determined based on the position and the inclination of the virtual camera 404. FIG. 12A is a YZ plane diagram of the field-of-view region 408 as viewed from the X direction, and FIG. 12B is an XZ plane diagram of the field-of-view region 408 as viewed from the Y direction.

The field-of-view region 408 has a first region 414 (see FIG. 12A) that is a range defined by the reference line of sight 412 and the YZ cross section of the virtual space image 410, and a second region 416 (see FIG. 12B) that is a range defined by the reference line of sight 412 and the XZ cross section of the virtual space image 410. The first region 414 is set as a range of a polar angle α or more from the reference line of sight 412 serving as the center. The second region 416 is set as a range of an azimuth β or more from the reference line of sight 412 serving as the center.

In Step 716, the field-of-view image generating unit 614 generates the field-of-view image 418 based on the field-of-view region 408. The field-of-view image 418 includes two two-dimensional images for the right eye and the left eye, and those images are superimposed on the display 112 to provide the virtual space 402 being a three-dimensional image to the user. In Step 718, the display control unit 602 outputs the information relating to the field-of-view image 418 to the HMD 110. The HMD 110 displays the field-of-view image 418 on the display 112 based on the received information of the field-of-view image 418. FIG. 12C is an example of the field-of-view image 418 to be displayed on the display 112 at this time. The processing ends in Step 720.

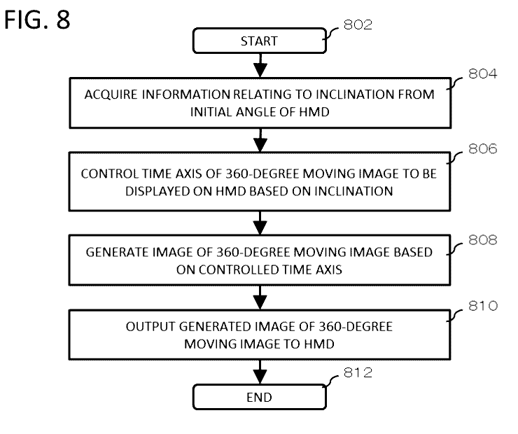

FIG. 8 is a flow chart for illustrating basic processing for displaying an image of a 360-degree moving image having a determined time axis on the HMD 110, which is achieved by a system according to at least one embodiment of this disclosure. With the processing described with reference to FIG. 7, the field-of-view image 418 of the 360-degree moving image at an initial position and an initial angle of the HMD 110 is generated in advance, and the field-of-view image 418 is output to the HMD 110 to be displayed on the HMD 110.

In order to shift to the processing illustrated in FIG. 8, some operations may be used. For example, the control circuit unit 120 may shift to the processing of FIG. 8 in response to the determination made by the display control unit 602 (HMD movement detecting unit 606, line-of-sight detecting unit 608, inclination determining unit 618, or the like) that the user is facing a specific direction for a certain time period or more. The control circuit unit 120 may further shift to the processing of FIG. 8 in response to the determination that the user has shaken his/her head vertically for a predetermined number of times (or more), that the user has turned his/her neck for a predetermined number of times (or more), that the user has jumped, that (in the case of an HMD including a controller) the user has performed a predetermined input operation with use of the controller, and that (in the case of an HMD including a microphone device) the user's voice or other predetermined sounds have been input. One of ordinary skill in the art would understand that various operations for shifting to the processing of FIG. 8 according to at least one embodiment of this disclosure are conceivable. The processing starts in Step 802. When the user wearing the HMD 110 moves his/her neck or head to change the inclination of the HMD 110, the movement sensor 130 detects the information relating to the inclination of the HMD 110, and the information is transmitted to the control circuit unit 120. In Step 804, the HMD movement detecting unit 606 compares the received information relating to the inclination with the initial angle of the HMD 110 to acquire information relating to the inclination from the initial angle of the HMD 110. In Step 806, the time-axis control unit 616 controls the time axis of the 360-degree moving image based on the acquired inclination information. Specific processing of the time axis control is described later. In Step 808, the control circuit unit 120 generates an image of the 360-degree moving image based on the controlled time axis. For example, the control circuit unit 120 generates an image to be displayed on the HMD 110 based on the field-of-view image 418 generated in FIG. 7, the information of the time axis obtained by Step 806, the information of the 360-degree moving image stored in the storage unit 624, and the like. In Step 810, the display control unit 602 outputs the generated image of the 360-degree moving image to the HMD.

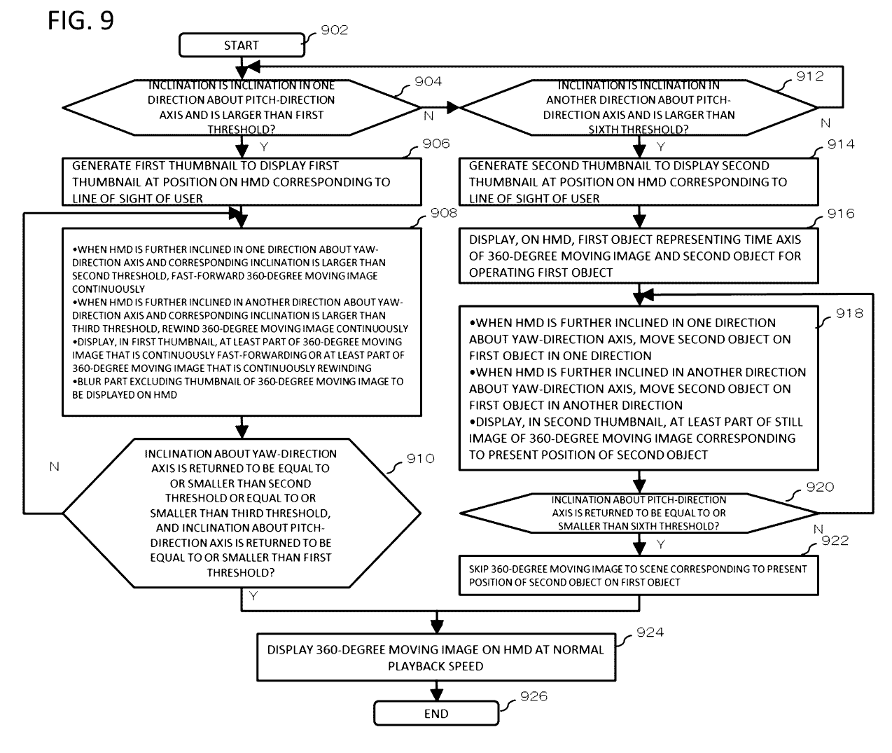

Now, with reference to FIG. 6, FIG. 9, and subsequent figures, processing for providing the 360-degree moving image having a determined time axis to the HMD according to at least one embodiment of this disclosure is described.

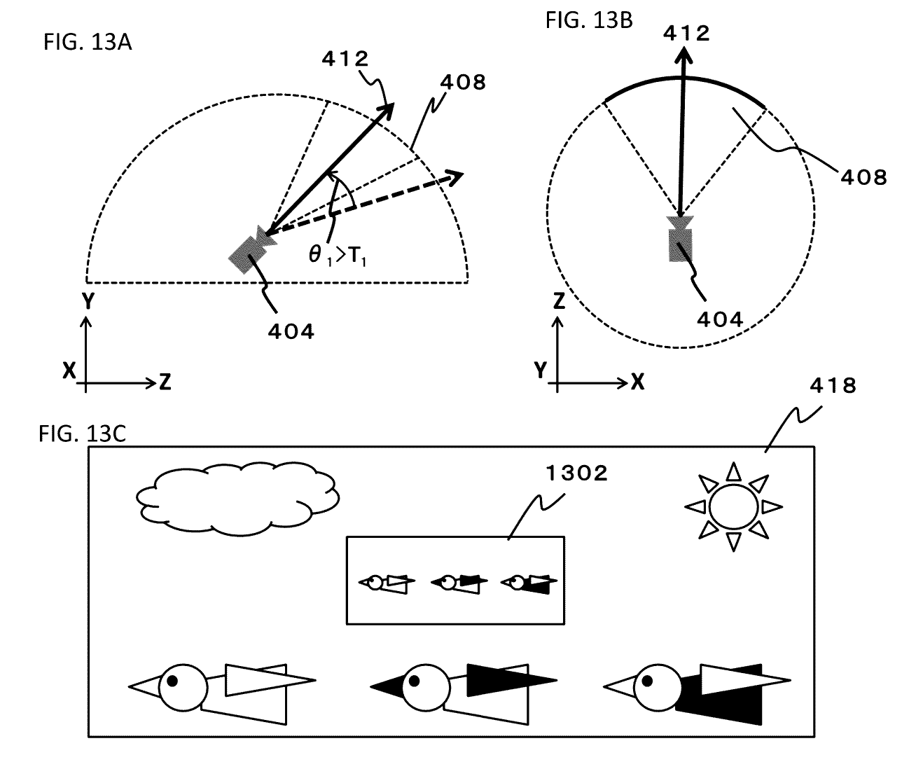

FIG. 9 is a flow chart for illustrating an example of the processing from Step 806 to Step 810 in FIG. 8. The processing starts in Step 902. In Step 904, the inclination determining unit 618 determines whether or not the inclination (inclination from the initial angle, which is acquired in Step 804) is an inclination in one direction about the pitch-direction axis (upward direction or downward direction, upward direction in the following example), and whether or not the inclination is larger than a first threshold. The first threshold may be stored in the storage unit 624 in advance. When the inclination is an inclination θ₁ in one direction about the pitch-direction axis, and is larger than a first threshold T₁ (“Y” in Step 904), the processing proceeds to Step 906. FIG. 13A and FIG. 13B are respectively examples of a YZ plane diagram of the field-of-view region 408 as viewed from the X direction at this time and an XZ plane diagram of the field-of-view region 408 as viewed from the Y direction at this time. In the following, the inclination of the virtual camera 404 in the virtual space 402 is represented as an inclination corresponding to the inclination of the HMD 110 in a real space. However, the inclination of the virtual camera 404 in the virtual space 402 is not required to have the same value as the inclination of the HMD 110, and may be changed so as to reflect the change in inclination of the HMD 110. The reference line of sight 412 is changed from the original direction indicated by the dotted-line arrow to the direction indicated by the solid-line arrow by the angle θ₁. In Step 906, the thumbnail generating and displaying unit 620 generates a first thumbnail 1302 to display the first thumbnail 1302 at a position on the HMD 110 corresponding to the line of sight of the user, which is detected by the eye gaze sensor 140 or the line-of-sight detecting unit 608. FIG. 13C is an example of the field-of-view image 418 and the first thumbnail 1302 to be displayed on the display 112 at this time. The first thumbnail 1302 is displayed on the field-of-view image 418 in a superimposed manner. In FIG. 13A to FIG. 13C, the reference line of sight 412 is changed upward about the pitch-direction axis as compared to the case of FIG. 12A to FIG. 12C. Therefore, in FIG. 13C, an image corresponding to a further upper part in the virtual space 402 as compared to the case of FIG. 12C is displayed.

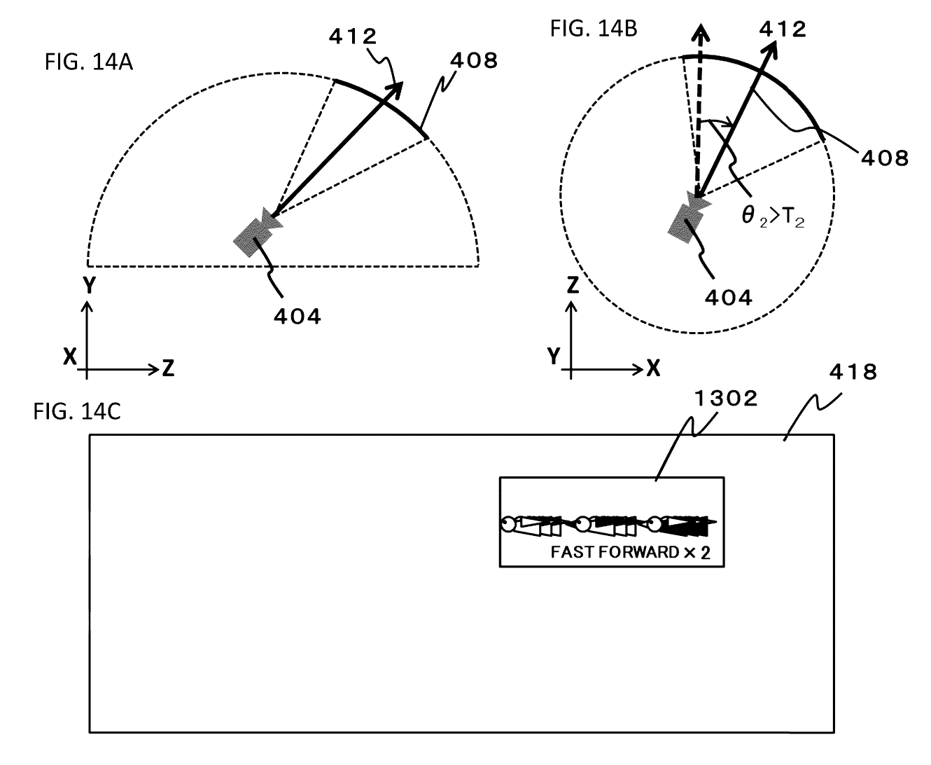

In Step 908, when the HMD 110 is further inclined in one direction about the yaw-direction axis (right direction or left direction, right direction in the following example), and the inclination determining unit 618 determines that the inclination θ₂ is larger than a second threshold T₂, the display control unit 602 (time-axis control unit 616) fast-forwards the 360-degree moving image continuously. FIG. 14A and FIG. 14B are respectively examples of a YZ plane diagram of the field-of-view region 408 as viewed from the X direction at this time and an XZ plane diagram of the field-of-view region 408 as viewed from the Y direction at this time. In FIG. 14B, the reference line of sight 412 is changed from the original direction indicated by the dotted-line arrow to the direction indicated by the solid-line arrow.

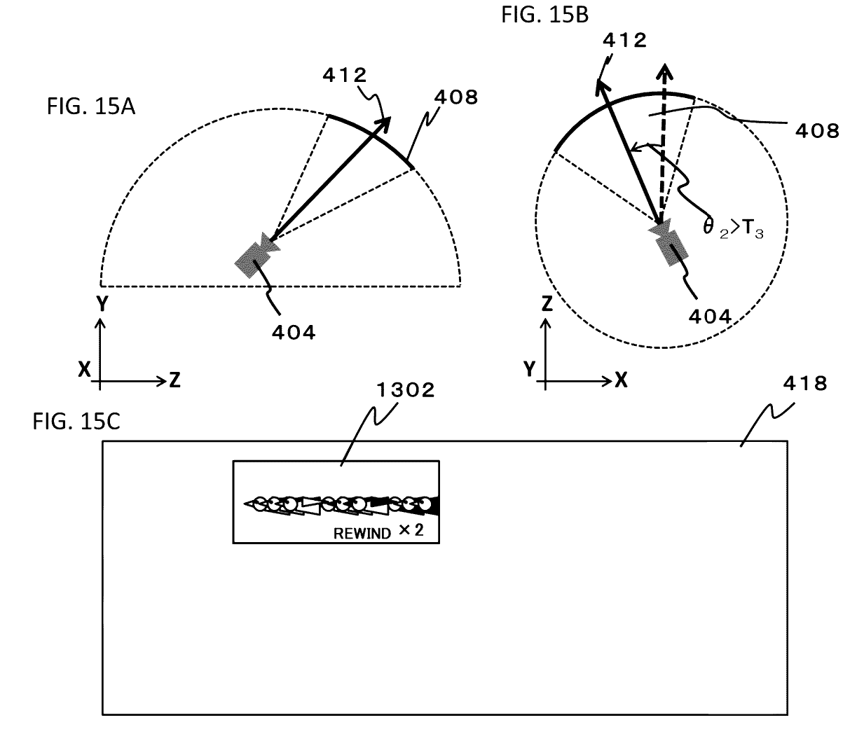

In Step 908, when the HMD is further inclined in another direction about the yaw-direction axis (left direction in this example), and the inclination determining unit 618 determines that the inclination θ₂ is larger than a third threshold T₃, the display control unit 602 (time-axis control unit 616) rewinds the 360-degree moving image continuously. FIG. 15A and FIG. 15B are respectively examples of a YZ plane diagram of the field-of-view region 408 as viewed from the X direction at this time and an XZ plane diagram of the field-of-view region 408 as viewed from the Y direction at this time. In FIG. 15B, the reference line of sight 412 is changed from the original direction indicated by the dotted-line arrow to the direction indicated by the solid-line arrow.

In Step 908, further, the thumbnail generating and displaying unit 620 displays, in the first thumbnail 1302, at least a part of the 360-degree moving image that is continuously fast-forwarding or at least a part of the 360-degree moving image that is continuously rewinding. FIG. 14C and FIG. 15C are examples of the field-of-view image 418 and the first thumbnail 1302 to be displayed on the display 112 at this time. The speed of fast-forwarding or rewinding with respect to a normal playback speed, e.g., “×2”, may be displayed in the first thumbnail 1302. The display control unit 602 may blur a part excluding the first thumbnail 1302 of the 360-degree moving image (in this case, the field-of-view image 418) to be displayed on the HMD by various methods including mosaic processing and the like. With this, the user can concentrate on the fast-forwarding operation or the rewinding operation using the first thumbnail 1302.

When the inclination in the one direction about the yaw-direction axis is larger than the second threshold T₂ and is equal to or smaller than a fourth threshold T₄, the display control unit 602 may fast-forward the 360-degree moving image continuously at a speed that is a first multiple (for example, two times) of the normal playback speed, and when the inclination in the one direction about the yaw-direction axis is larger than the fourth threshold T₄, the display control unit 602 may fast-forward the 360-degree moving image continuously at a speed that is a second multiple (for example, three times), which is larger than the first multiple, of the normal playback speed. Further, when the inclination in the another direction about the yaw-direction axis is larger than the third threshold T₃ and is equal to or smaller than a fifth threshold T₅, the display control unit 602 may rewind the 360-degree moving image continuously at a speed that is a third multiple (for example, two times) of the normal playback speed, and when the inclination in the another direction about the yaw-direction axis is larger than the fifth threshold T₅, the display control unit 602 may rewind the 360-degree moving image continuously at a speed that is a fourth multiple (for example, three times), which is larger than the third multiple, of the normal playback speed. Other than the above, the fast-forwarding and rewinding speeds may be set variously under various conditions.

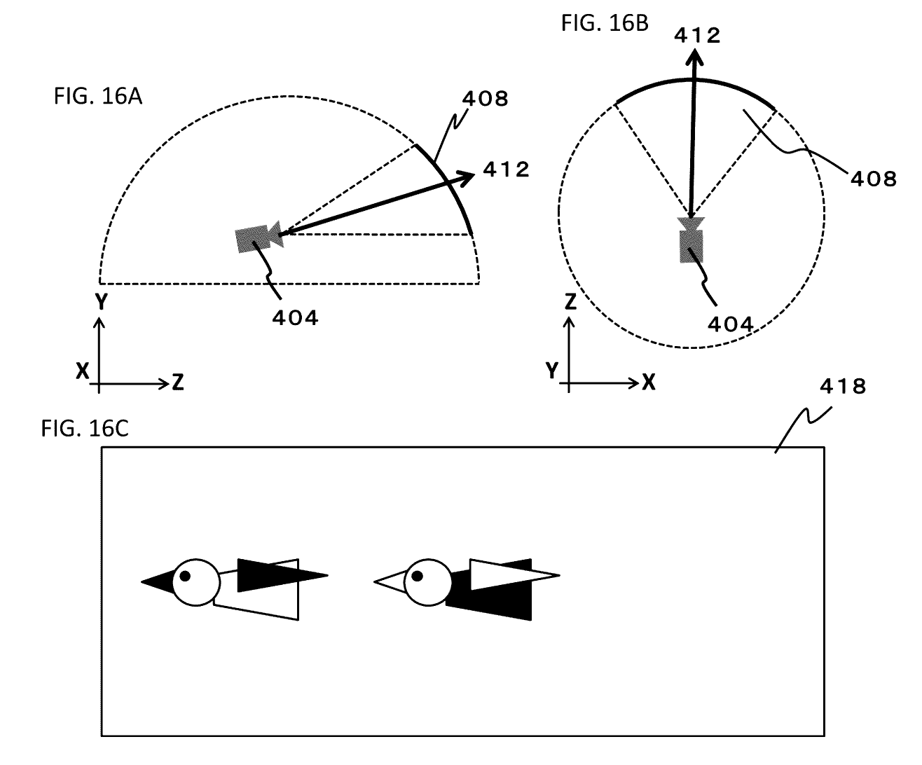

In Step 910, the inclination determining unit 618 determines whether or not the inclination about the yaw-direction axis is returned to be equal to or smaller than the second threshold T₂ or equal to or smaller than the third threshold T₃, and the inclination about the pitch-direction axis is returned to be equal to or smaller than the first threshold T₁. When those inclinations satisfy the above-mentioned conditions (“Y” in Step 910), the processing proceeds to Step 924. In Step 924, the display control unit 602 displays the 360-degree moving image on the HMD 110 at the normal playback speed. FIG. 16A and FIG. 16B are respectively examples of a YZ plane diagram of the field-of-view region 408 as viewed from the X direction at this time and an XZ plane diagram of the field-of-view region 408 as viewed from the Y direction at this time. In this example, the reference line of sight 412 is returned to the initial direction. FIG. 16C is an example of the field-of-view image 418 to be displayed on the display 112 after the fast-forwarding. In the case of “N” in Step 910, the processing may return to Step 908. In Step 925, the processing ends.

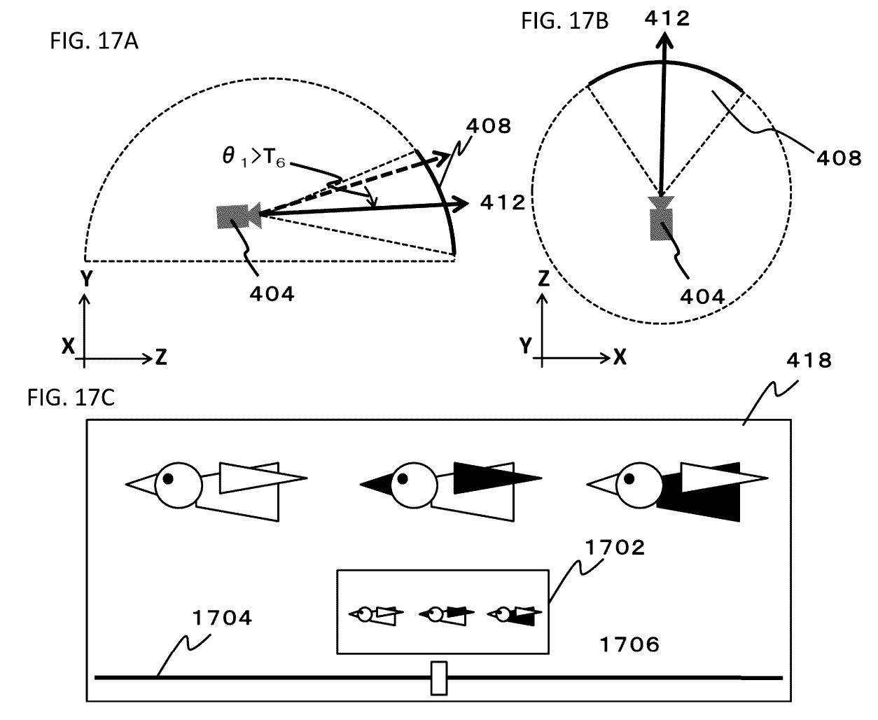

In the case of “N” in Step 904, the processing proceeds to Step 912. In Step 912, the inclination determining unit 618 determines whether or not the inclination (inclination from the initial angle, which is acquired in Step 804) is an inclination in another direction about the pitch-direction axis (downward direction in the following example), and whether or not the inclination is larger than a sixth threshold. The sixth threshold may be stored in the storage unit 624 in advance. When the inclination θ₁ is an inclination in another direction about the pitch-direction axis, and is larger than a sixth threshold T₆ (“Y” in Step 912), the processing proceeds to Step 914. FIG. 17A and FIG. 17B are respectively examples of a YZ plane diagram of the field-of-view region 408 as viewed from the X direction at this time and an XZ plane diagram of the field-of-view region 408 as viewed from the Y direction at this time. In FIG. 17A, the reference line of sight 412 is changed from the original direction indicated by the dotted-line arrow to the direction indicated by the solid-line arrow. In Step 914, the thumbnail generating and displaying unit 620 generates a second thumbnail 1702 to display the second thumbnail 1702 at a position on the HMD 110 corresponding to the line of sight of the user. On the other hand, in the case of “N” in Step 912, the processing may return to Step 904.

In Step 916, the object generating and displaying unit 622 displays, on the HMD, a first object 1704 representing the time axis of the 360-degree moving image and a second object 1706 for operating the first object 1704. FIG. 17C is an example of the field-of-view image 418, the second thumbnail 1702, the first object 1704, and the second object 1706 to be displayed on the display 112 at this time. The second thumbnail 1702 may be arranged near the second object 1706.

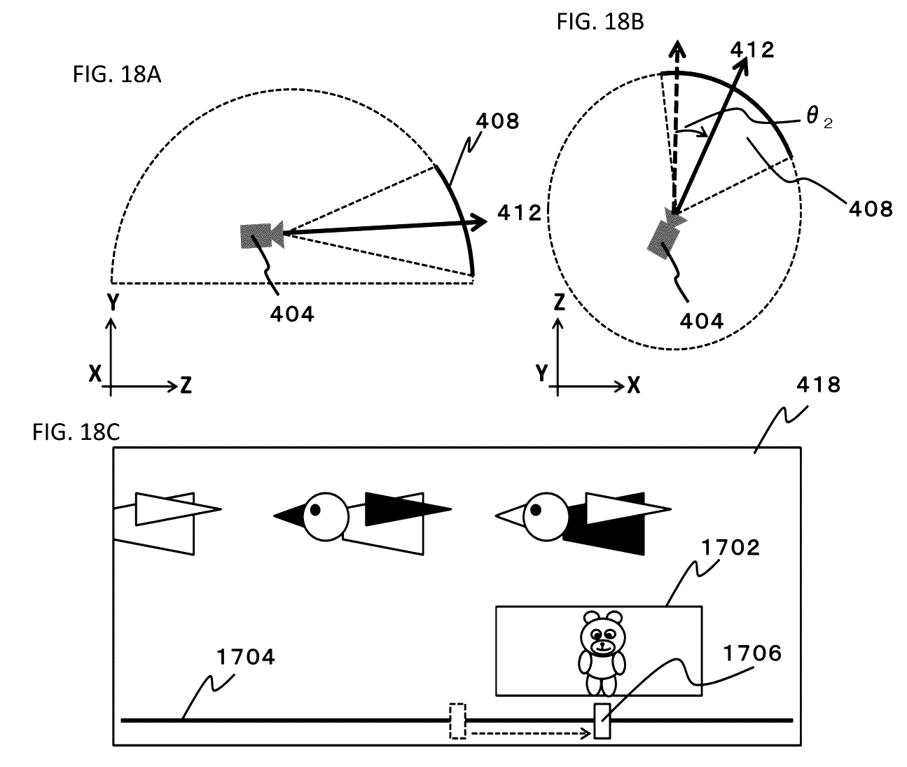

In Step 918, when the HMD 110 is further inclined in the one direction about the yaw-direction axis (right direction in this case), the object generating and displaying unit 622 moves the second object 1706 on the first object 1704 in the one direction. FIG. 18A and FIG. 18B are respectively examples of a YZ plane diagram of the field-of-view region 408 as viewed from the X direction at this time and an XZ plane diagram of the field-of-view region 408 as viewed from the Y direction at this time. The thumbnail generating and displaying unit 620 displays, in the second thumbnail 1702, at least a part of a still image of the 360-degree moving image corresponding to the present position of the second object 1706. FIG. 18C is an example of the field-of-view image 418, the second thumbnail 1702, the first object 1704, and the second object 1706 to be displayed on the display 112 at this time. One of ordinary skill in the art would understand that an image of a scene different from the present field-of-view image 418 is displayed on the second thumbnail 1702.

In Step 918, when the HMD 110 is further inclined in the another direction about the yaw-direction axis, the second object 1706 is moved on the first object 1704 in the another direction.

In Step 920, the inclination determining unit 618 determines whether or not the inclination about the pitch-direction axis is returned to be equal to or smaller than the sixth threshold with respect to the initial angle. When the inclination is returned (“Y” in Step 920), the processing proceeds to Step 922, and the display control unit 602 skips the 360-degree moving image to a scene corresponding to the present position of the second object 1706 on the first object 1704. In the case of “N” in Step 920, the processing may return to Step 918.

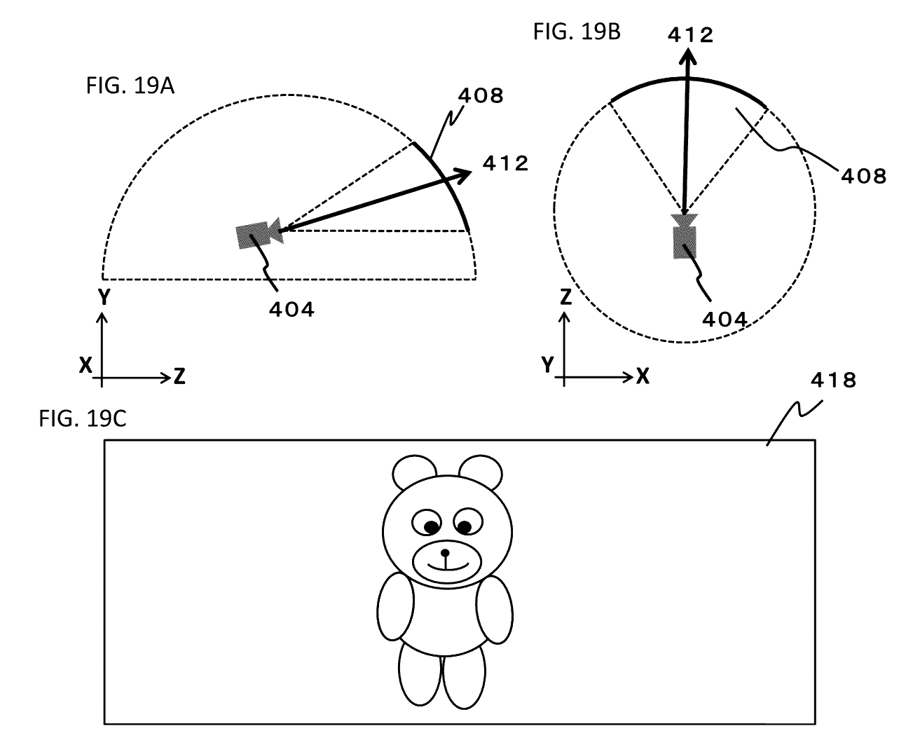

In Step 924, the display control unit 602 displays the 360-degree moving image on the HMD at the normal playback speed. FIG. 19A and FIG. 19B are respectively examples of a YZ plane diagram of the field-of-view region 408 as viewed from the X direction at this time and an XZ plane diagram of the field-of-view region 408 as viewed from the Y direction at this time. The reference line of sight 412 is returned to the initial direction. FIG. 19C is an example of the field-of-view image 418 to be displayed on the display 112 at this time. One of ordinary skill in the art would understand that skipping has been performed to a scene that has been displayed on the second thumbnail 1702 in FIG. 18C. In Step 925, the processing ends.

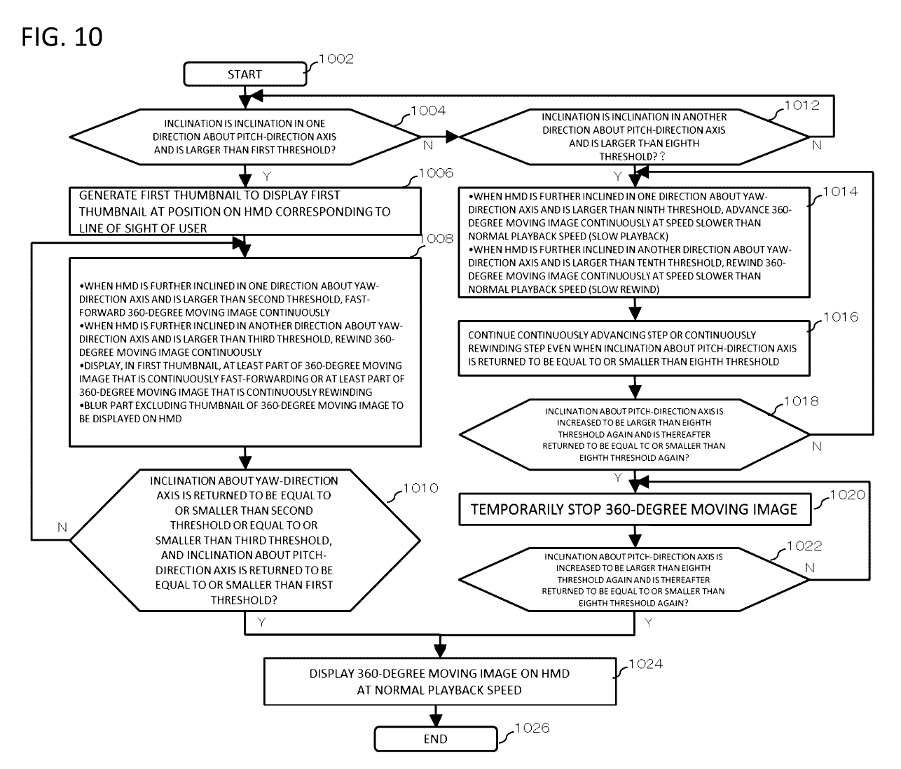

FIG. 10 is a flow chart for illustrating an example of the processing from Step 806 to Step 810 in FIG. 8. The processing starts in Step 1002. The processing from Step 1004 to Step 1010 is similar to the processing from Step 904 to Step 910, and hence description thereof is omitted.

In Step 1004, when the inclination determining unit 618 determines that the inclination from the initial angle of the HMD 110 is not the inclination in the one direction about the pitch-direction axis and/or is equal to or smaller than the first threshold (“N” in Step 1004), the processing proceeds to Step 1012. In Step 1012, the inclination determining unit 618 determines whether or not the inclination (inclination from the initial angle, which is acquired in Step 804) is an inclination in the another direction about the pitch-direction axis (downward direction in the following example), and whether or not the magnitude θ₁ of the inclination is larger than an eighth threshold. The eighth threshold may be stored in the storage unit 624 in advance. In the case of “Y” in Step 1012, the processing proceeds to Step 1014. On the other hand, in the case of “N” in Step 1012, the processing may return to Step 1004.

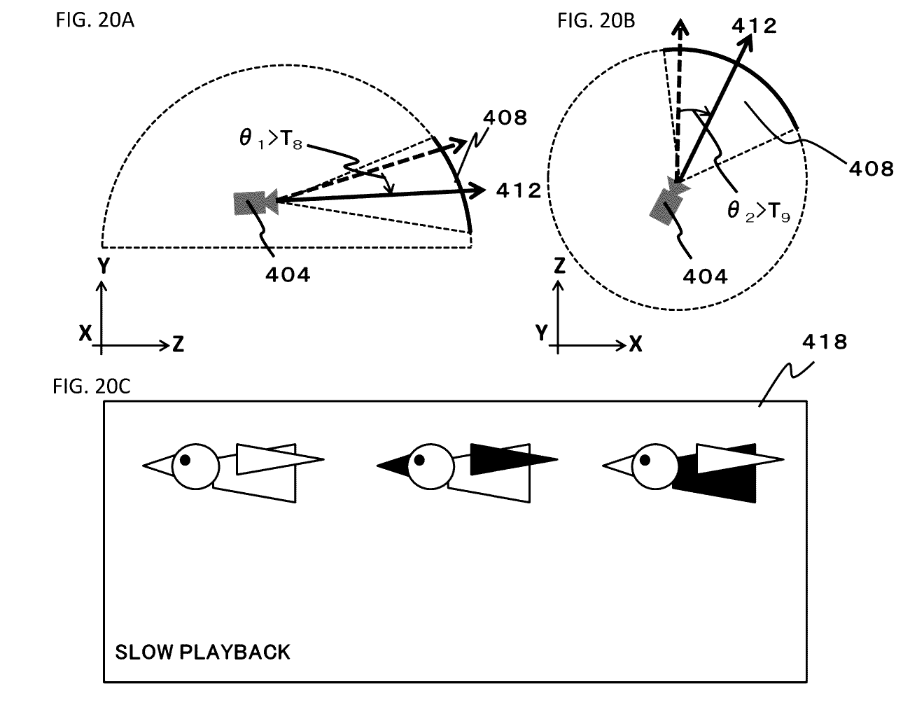

In Step 1014, when the inclination determining unit 618 determines that the HMD 110 is further inclined by the angle θ₂ in the one direction about the yaw-direction axis (right direction in this example) and the inclination is larger than a ninth threshold T₉, the display control unit 602 continuously advances the 360-degree moving image at a speed slower than the normal playback speed (slow playback). The speed at this time can be set variously in accordance with the magnitude of the angle θ₂. For example, when θ₂ is larger than the ninth threshold T₉ and is equal to or smaller than an eleventh threshold T₁₁, the above-mentioned speed may be 0.5 times as fast as the normal playback speed. Further, when θ₂ is larger than the eleventh threshold T₁₁, the above-mentioned speed may be 0.25 times as fast as the normal playback speed. FIG. 20A and FIG. 20B are respectively examples of a YZ plane diagram of the field-of-view region 408 as viewed from the X direction at this time and an XZ plane diagram of the field-of-view region 408 as viewed from the Y direction at this time. The reference line of sight 412 is changed from the original direction indicated by the dotted-line arrow to the direction indicated by the solid-line arrow. FIG. 20C is an example of the field-of-view image 418 to be displayed on the display 112 at this time. The 360-degree moving image is played in slow motion.

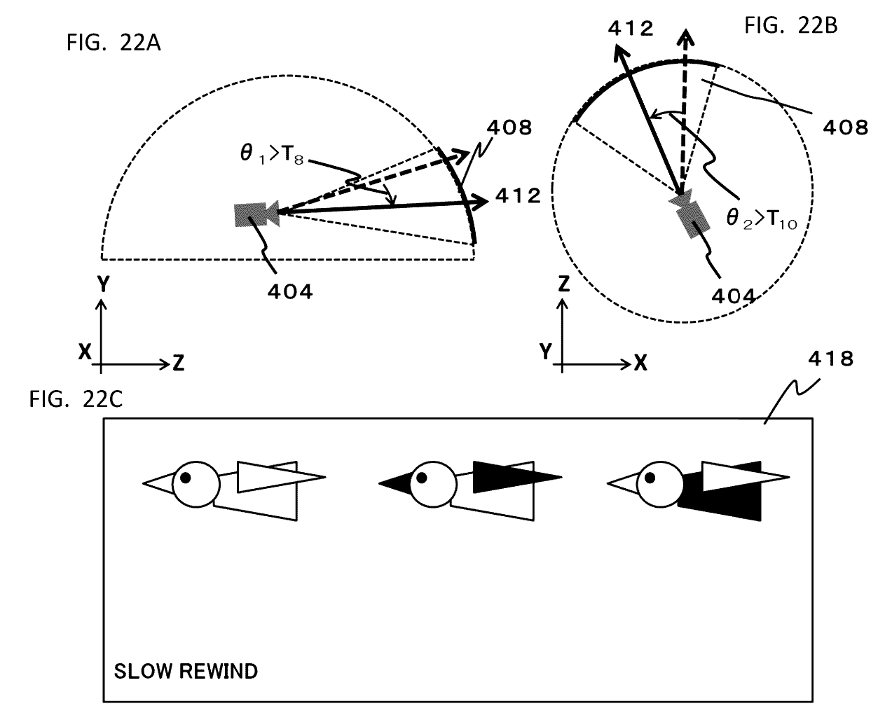

Further, in Step 1014, when the inclination determining unit 618 determines that the HMD 110 is further inclined in the another direction about the yaw-direction axis (left direction in this example) and that the magnitude of the inclination is larger than a tenth threshold T₁₀, the display control unit 602 continuously rewinds the 360-degree moving image at a speed slower than the normal playback speed (slow rewind). FIG. 22A and FIG. 22B are respectively examples of a YZ plane diagram of the field-of-view region 408 as viewed from the X direction at this time and an XZ plane diagram of the field-of-view region 408 as viewed from the Y direction at this time. FIG. 22C is an example of the field-of-view image 418 to be displayed on the display 112 at this time. The 360-degree moving image is rewound in slow motion.

According to at least one embodiment of this disclosure, different processing may be executed in place of the processing of Step 1014. For example, in the case of “Y” in Step 1012, the display control unit 602 may continuously advance the 360-degree moving image at a speed slower than the normal playback speed (slow playback), or may continuously rewind the 360-degree moving image at a speed slower than the normal playback speed (slow rewind).

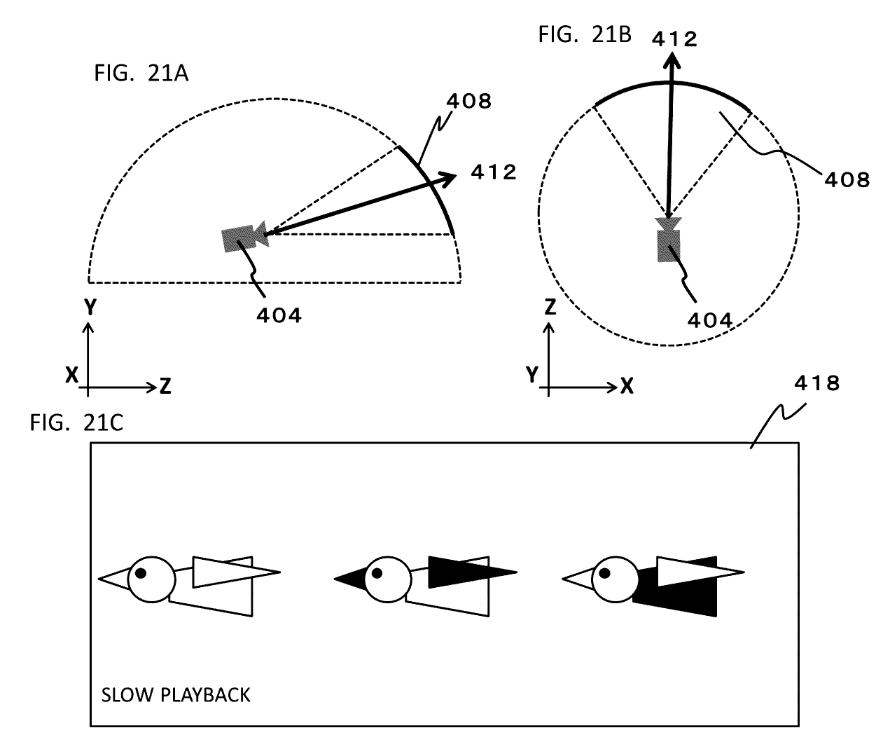

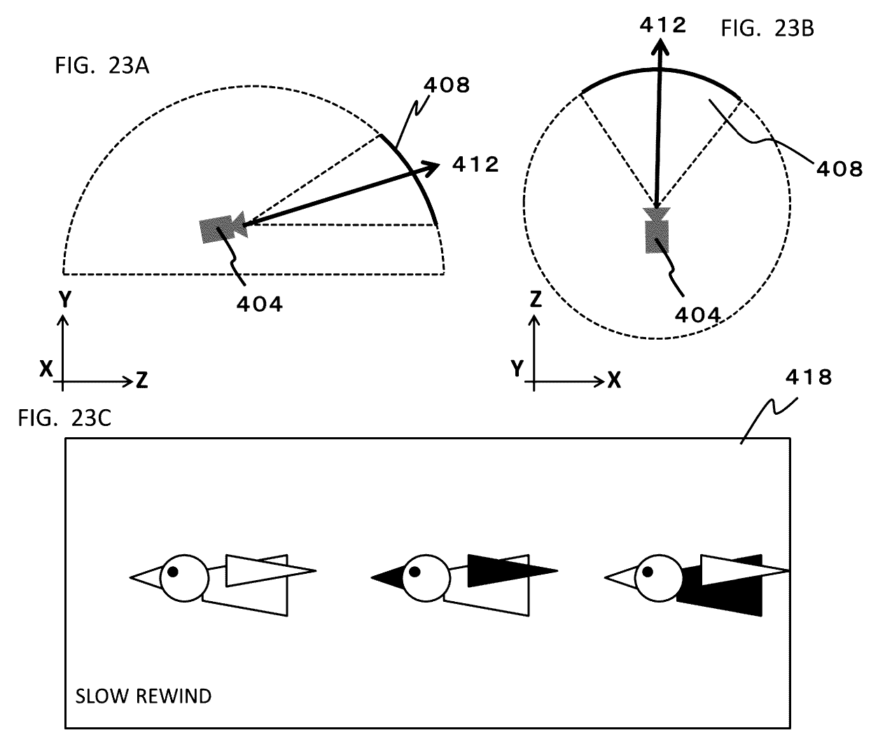

In Step 1016, even when the inclination determining unit 618 determines that the inclination about the pitch-direction axis is returned to be equal to or smaller than the eighth threshold, the display control unit 602 continues the continuously advancing step or the continuously rewinding step, which is described in Step 1014. FIG. 21A and FIG. 21B, and FIG. 23A and FIG. 23B are respectively examples of a YZ plane diagram of the field-of-view region 408 as viewed from the X direction at this time and an XZ plane diagram of the field-of-view region 408 as viewed from the Y direction at this time. In any of the cases, one of ordinary skill in the art would understand that the reference line of sight 412 is returned to the initial direction. However, as illustrated in FIG. 21C or FIG. 23C, the slow playback or the slow rewind of the 360-degree moving image is continued.

In Step 1018, the inclination determining unit 618 determines whether or not the inclination about the pitch-direction axis is increased to be larger than the eighth threshold again, and is thereafter returned to be equal to or smaller than the eighth threshold again. In the case of “Y” in Step 1018, the processing may proceed to Step 1020 so that the display control unit 602 may temporarily stop the 360-degree moving image. Alternatively, the display control unit 602 may display the 360-degree moving image on the HMD 110 at the normal playback speed. In the case of “N” in Step 1018, the processing may return to Step 1014.

In Step 1022, the inclination determining unit 618 determines whether or not the inclination about the pitch-direction axis is further increased to be larger than the eighth threshold again, and is thereafter returned to be equal to or smaller than the eighth threshold again. In the case of “Y” in Step 1022, the processing proceeds to Step 1024, and the display control unit 602 displays the 360-degree moving image on the HMD 110 at the normal playback speed. In the case of “N” in Step 1022, the processing may return to Step 1020. In Step 1025, the processing ends.

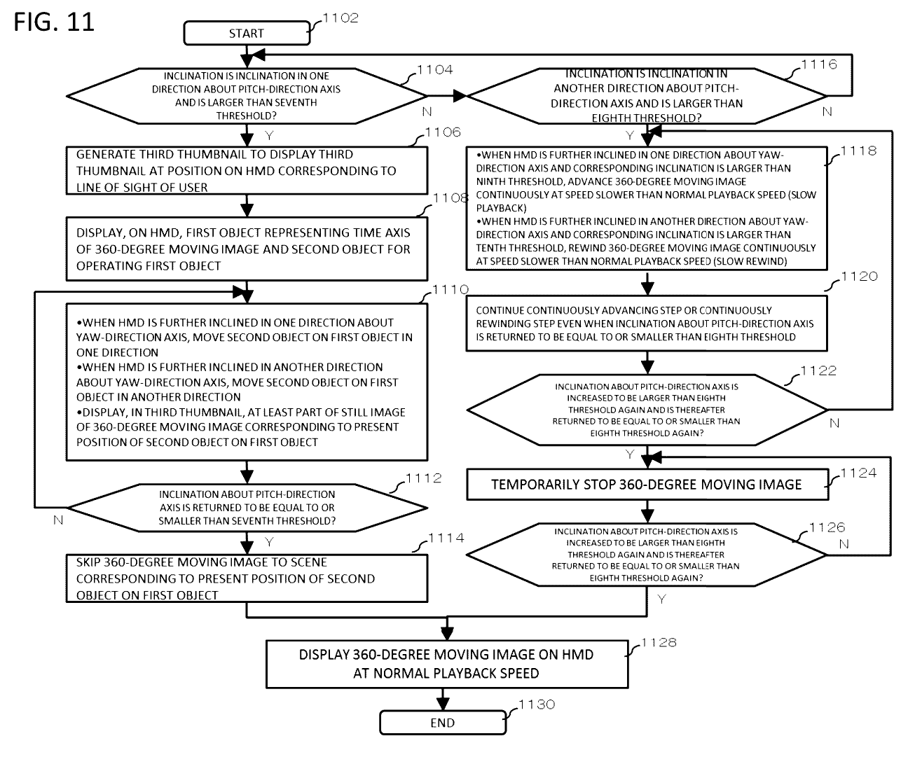

FIG. 11 is a flow chart for illustrating an example of the processing from Step 806 to Step 810 in FIG. 8. The processing starts in Step 1102. In Step 1104, the inclination determining unit 618 determines whether or not the inclination (inclination from the initial angle, which is acquired in Step 804) is an inclination in one direction about the pitch-direction axis (upward direction in this example), and whether or not the inclination is larger than a seventh threshold. The seventh threshold may be stored in the storage unit 624 in advance. In the case of “Y” in Step 1104, the processing proceeds to Step 1106. The processing from Step 1106 to Step 1114 is the same as the processing from Step 914 to Step 922, and hence description thereof is omitted.

In the case of “N” in Step 1104, the processing proceeds to Step 1116. In Step 1116, the inclination determining unit 618 determines whether or not the inclination is an inclination in another direction about the pitch-direction axis (downward direction in this example), and whether or not the inclination is larger than the eighth threshold. In the case of “Y” in Step 1116, the processing proceeds to Step 1118. The processing from Step 1118 to Step 1126 is similar to the processing from Step 1014 to Step 1022. In the case of “N” in Step 1116, the processing may return to Step 1104.

In Step 1128, the display control unit 602 displays the 360-degree moving image on the HMD 110 at the normal playback speed. In Step 1130, the processing ends.

According to at least one embodiments described above, providing a comfortable operability to a user when the user uses an HMD to view a 360-degree moving image having a determined time axis is possible.

The system according to embodiments of this disclosure have been specifically described above, but the above-mentioned embodiments are merely examples, and are not intended to limit the scope of this disclosure. One of ordinary skill in the art would understand that the technical idea of this disclosure can be embodied in various modes including a computer-executable method including the described steps of the embodiments in addition to the program and the computer. Further, one of ordinary skill in the art would undrstand that a change, addition, or modification may be appropriately made to the embodiments without departing from the gist and the scope of this disclosure. The scope of this disclosure is to be interpreted based on the description of the appended claims and is to be understood to include equivalents thereof.

What is claimed is:

1. A system for executing a method of providing, to a head mounted display, a 360-degree moving image having a determined time axis, the system is configured to:
control, in response to an inclination from an initial angle of the head mounted display, a time axis of the 360-degree moving image to be displayed on the head mounted display based on the inclination;
generate an image of the 360-degree moving image based on the controlled time axis; and
output the generated image of the 360-degree moving image to the head mounted display.

2. The system according to claim 1, wherein the system is configured to, in response to the inclination in one direction about a pitch-direction axis with respect to the initial angle and exceeds a first threshold:
fast-forward the 360-degree moving image continuously when the head mounted display is further inclined in one direction about a yaw-direction axis with respect to the initial angle and in response to the inclination exceeding a second threshold; and
rewind the 360-degree moving image continuously when the head mounted display is further inclined in another direction about the yaw-direction axis with respect to the initial angle and in response to the inclination exceeding a third threshold.

3. The system according to claim 2,
wherein the system is further configured to:
fast-forward the 360-degree moving image continuously at a speed that is a first multiple of a normal playback speed in response to the inclination in the one direction about the yaw-direction axis exceeding the second threshold and being equal to or smaller than a fourth threshold;
fast-forward the 360-degree moving image continuously at a speed that is a second multiple, which is larger than the first multiple, of the normal playback speed in response to the inclination in the one direction about the yaw-direction axis exceeding the fourth threshold;
rewind the 360-degree moving image continuously at a speed that is a third multiple of the normal playback speed in response to the inclination in the another direction about the yaw-direction axis exceeding the third threshold and being equal to or smaller than a fifth threshold; and
rewind the 360-degree moving image continuously at a speed that is a fourth multiple, which is larger than the third multiple, of the normal playback speed in response to the inclination in the another direction about the yaw-direction axis exceeding the fifth threshold.

4. The system according to claim 2, wherein the system is further configured to:
display, in response to the inclination in the one direction about the pitch-direction axis with respect to the initial angle and exceeds the first threshold, a first thumbnail at a position on the head mounted display corresponding to a line of sight of a user wearing the head mounted display; and
display, in the first thumbnail, one of at least a part of the 360-degree moving image that is continuously fast-forwarding and at least a part of the 360-degree moving image that is continuously rewinding.

5. The system according to claim 4, wherein the system is configured to blur a part excluding the first thumbnail of the 360-degree moving image to be displayed on the head mounted display during the fast-forwarding and/or the rewinding.

6. The system according to claim 2, wherein, in response to the inclination about the yaw-direction axis returning to be equal to or less than one of the second threshold or the third threshold, and in response to the inclination about the pitch-direction axis returning to be equal to or less than the first threshold, the system is configured to display the 360-degree moving image on the head mounted display at a normal playback speed.

7. The system according to claim 2, wherein the system is configured to, in response to the inclination in another direction about the pitch-direction axis with respect to the initial angle and exceeds a sixth threshold:
display, on the head mounted display, a first object representing the time axis of the 360-degree moving image and a second object for operating the first object;
move, in response to the head mounted display being further inclined in one direction about the yaw-direction axis with respect to the initial angle, the second object on the first object in the one direction;
move, in response to the head mounted display being further inclined in another direction about the yaw-direction axis with respect to the initial angle, the second object on the first object in the another direction; and
skip, in response to the inclination about the pitch-direction axis returning to be equal to or less than the sixth threshold, the 360-degree moving image to a scene corresponding to a present position of the second object on the first object.

8. The system according to claim 7, wherein the system is further configured to:
display, in response to the inclination in the another direction about the pitch-direction axis with respect to the initial angle and exceeding the sixth threshold, a second thumbnail at a position on the head mounted display corresponding to a line of sight of a user wearing the head mounted display; and
display, in the second thumbnail, at least a part of a still image of the 360-degree moving image corresponding to the present position of the second object on the first object.

9. They system according to claim 7, wherein the system is further configured to, while the first object and the second object are displayed, play the 360-degree moving image on the head mounted display at a normal playback speed.

10. The system according to claim 1, wherein the system is further configured to, in response to the inclination in one direction about a pitch-direction axis with respect to the initial angle and exceeding a seventh threshold:
display, on the head mounted display, a first object representing the time axis of the 360-degree moving image and a second object for operating the first object;
move, in response to the head mounted display is further inclined in one direction about the yaw-direction axis with respect to the initial angle, the second object on the first object in the one direction;
move, in response to the head mounted display is further inclined in another direction about the yaw-direction axis with respect to the initial angle, the second object on the first object in the another direction; and
skip, in response to the inclination about the pitch-direction axis returning to be equal to or less than the seventh threshold, the 360-degree moving image to a scene corresponding to a present position of the second object on the first object.

11. The system according to claim 10, wherein the system is further configured to:
display, in response to the inclination in the one direction about the pitch-direction axis with respect to the initial angle and exceeding the seventh threshold, a third thumbnail at a position on the head mounted display corresponding to a line of sight of a user wearing the head mounted display; and
display, in the third thumbnail, at least a part of a still image of the 360-degree moving image corresponding to the present position of the second object on the first object.

12. The system according to claim 10, wherein the system is further configured to, while the first object and the second object are displayed, play the 360-degree moving image on the head mounted display at a normal playback speed.

13. The system according to claim 2, wherein the system is further configured to, in response to the inclination in another direction about the pitch-direction axis with respect to the initial angle and exceeding an eighth threshold:
advance the 360-degree moving image continuously at a speed slower than a normal playback speed when the head mounted display is further inclined in the one direction about the yaw-direction axis with respect to the initial angle and when the inclination exceeds a ninth threshold; and
rewind the 360-degree moving image continuously at a speed slower than the normal playback speed when the head mounted display is further inclined in the another direction about the yaw-direction axis with respect to the initial angle and when the inclination exceeds a tenth threshold.

14. The system according to claim 13, wherein the the system is further configured to:
continue one of the advancing the 360-degree moving image continuously or rewind the 360-degree moving image continuously in response to the inclination about the pitch-direction axis returning to be equal to or less than the eighth threshold; and
one of temporarily stop the 360-degree moving image or advance the 360-degree moving image at the normal playback speed in response to the inclination about the pitch-direction axis exceeding the eighth threshold again and thereafter returning to be equal to or smaller than the eighth threshold again.

15. The system according to claim 2, wherein the system is configured to, in response to the inclination in another direction about the pitch-direction axis with respect to the initial angle and exceeding an eighth threshold, advancing the 360-degree moving image continuously at a speed slower than a normal playback speed.

16. The system according to claim 15, wherein the system is further configured to:
continue advancing the 360-degree moving image continuously in response to the inclination about the pitch-direction axis returning to be equal to or smaller than the eighth threshold; and
one of temporarily stop the 360-degree moving image or advance the 360-degree moving image at the normal playback speed in response to the inclination about the pitch-direction axis exceeding the eighth threshold again and thereafter returning to be equal to or smaller than the eighth threshold again.

17. A method of providing, to a head mounted display, a 360-degree moving image having a determined time axis, the method comprising:
controlling, in response to an inclination from an initial angle of the head mounted display, a time axis of the 360-degree moving image to be displayed on the head mounted display based on the inclination;
generating an image of the 360-degree moving image based on the controlled time axis; and
outputting the generated image of the 360-degree moving image to the head mounted display.

18. The method according to claim 17, wherein, in response to the inclination in one direction about a pitch-direction axis with respect to the initial angle and exceeds a first threshold:
fast-forwarding the 360-degree moving image continuously when the head mounted display is further inclined in one direction about a yaw-direction axis with respect to the initial angle and in response to the inclination exceeding a second threshold; and
rewinding the 360-degree moving image continuously when the head mounted display is further inclined in another direction about the yaw-direction axis with respect to the initial angle and in response to the inclination exceeding a third threshold.

19. The system according to claim 18, further comprising:
fast-forwarding the 360-degree moving image continuously at a speed that is a first multiple of a normal playback speed in response to the inclination in the one direction about the yaw-direction axis exceeding the second threshold and being equal to or smaller than a fourth threshold;
fast-forwarding the 360-degree moving image continuously at a speed that is a second multiple, which is larger than the first multiple, of the normal playback speed in response to the inclination in the one direction about the yaw-direction axis exceeding the fourth threshold;
rewinding the 360-degree moving image continuously at a speed that is a third multiple of the normal playback speed in response to the inclination in the another direction about the yaw-direction axis exceeding the third threshold and being equal to or smaller than a fifth threshold; and
rewinding the 360-degree moving image continuously at a speed that is a fourth multiple, which is larger than the third multiple, of the normal playback speed in response to the inclination in the another direction about the yaw-direction axis exceeding the fifth threshold.
